(19) United States
(12) Patent Application Publication
(10) Pub. No.: US 2005/0240694 A1
(43) Pub. Date: Oct. 27, 2005

(54) Home electronic resources sharing system

(75) Inventors: Tien-Chun Tseng, Taipei Hsien (TW); Chao-Hsin Chen, Taipei Hsien (TW)

Correspondence Address: BRUCE H. TROXELL, SUITE 1404, 5205 LEESBURG PIKE, FALLS CHURCH, VA, 22041, US

(73) Assignee: Wistron Corp.

(21) Appl. No.: 10/900,106

(22) Filed: Jul. 28, 2004

(30) Foreign Application Priority Data
Apr. 21, 2004 (TW) 093111172

(51) Int. Cl. G06F 13/00

(52) U.S. Cl. 710/100

(57) ABSTRACT

A home electronic resource-sharing system includes a plurality of interface units electrically connects with a bus and one of the interface units further connects with a management unit. Further, rest of the interface units connects with home electronic products to obtain simple and neater and forms a system with the electronic products. Hence, hard resource of the electronic products can be shared with each other in the system with powerful function of operation.

### BACKGROUND OF THE INVENTION

1. Field of the Invention

The present invention is related to a system associated with home electronic products such as personal computers, televisions, digital cameras/digital, DVD/DVR and video signal input/output interface and particularly to a system with which each electronic product can be joined to each other with a bus and software and hardware resource of each electronic product can be used with each other and controlled by the system so as to become a resource-sharing platform.

2. Brief Description of Related Art

After home electronic products having been networked and digitalized and wideband communication network such as asymmetric digital subscriber line (ADSL), cable TV network or satellite communication having been introduced to the home electronic products, the connection structure between electronic products becomes extremely complicated. TV and audio system 10 shown in FIG. 1 is a main audio playing tool. Various wideband video signal transmission interface such as satellite set-top box 11, internet protocol (IP) set-top box 12, cable set-top box 13 or Personal Video Recorder (PVR), DVD/DVR 14 and game machine 15 are connected to TV and audio system 10 with video signal transmission lines. A media center PC 20 is connected to the Digital Camera/Camcorder 21, MP3 player/Media2Go 22, PDA/Smart Phone 23, Smart Display 24, 2nd PC/Notebook 25, Storage 26, Broadband Gateway 27 and A/V Node 28. The A/V Node 28 joins TV and audio system 10 to allow the audio system 10 can play video information via the media center PC 20.

The IP set-top box 12 and the Broadband Gateway 27 are connected to ADSL and Cable Set-top Box 13 and Media Center PC 20 are connected to Cable. Digital Camera/Digital Camcorder 21 and MP3 Player/Media Player 22 are connected to signal transmission line via USB/IEEE1394 interface. Wireless signal can be transmitted between PDA/Smart Phone 23, Smart Display 24, 2nd PC/Notebook 25 and Media center PC 20. Ethernet can be used for connection between 2nd PC/Notebook 25, Storage 26 and Media Center PC 20.

Most of the preceding home electronic products need many signal lines for being connected to TV and Audio system 10 and Media center PC 20 but it results in extremely complicated joining lines. Further, most electronic products have individual operator, power supply, memory and storage and it results in resource dispersion and repeated investments. In addition, no consistent management institution is among the electronic products so that it is easy to perform management.

Another structure for joining the home electronic products is shown in FIG. 2. Satellite Set-top BOX 11, IP Set-top BOX 12, Cable Set-top BOX 13, Storage 26, Broadband Gateway 27 and A/V Node 28 are integrated as a media server 30 and video signals output from all the electronic products are sent to TV and audio system 10 via the media server 30. Although this type of joining structure can solve problem of complicated joining lines, the media server 30 or the media gateway provide sophisticate structure with high cost. The joining structure is belonged to a structure of central power control. When number of periphery electronic products increases or new function is added, wider communication band is needed and the CPU provides limited operation capability such that the media server 30 becomes a bottleneck of video signal transmission to lower quality of signal transmission. Once the media server 30 is shut down, operations of all home electronic products are influenced. If there are partitions for rooms in house, excessively controlled central power causes operation inconvenience. When each electronic product is updated technique thereof and added with new function, the user has to consider integral system and the media server 30 and periphery electronic products are renewed to increase the expense of purchasing the home electronic products.

### SUMMARY OF THE INVENTION

A primary object of the present invention is to provide a home electronic resource-sharing system such that various electronic products can constitute a system to share software and hardware with powerful function of operation.

Another object of the present invention is to provide a home electronic resource-sharing system with less and neat wiring of the main unit.

A further object of the present invention is to provide a home electronic resource-sharing system with which each electronic product has independent operation capability and can be renewed easily without influencing operations of related other electronic products so that cost for purchasing electronic products can be lowered significantly.

A home electronic resource-sharing system according to the present invention has a management system being connected to various electronic products so that the electronic products are associated with the management system to constitute the resource common sharing system.

### BRIEF DESCRIPTION OF THE DRAWINGS

The present invention can be more fully understood by reference to the following description and accompanying drawings, in which:

FIG. 1 is a block diagram illustrating a conventional structure linking various home electronic appliances;

FIG. 2 is a block diagram illustrating another conventional structure linking various home electronic appliances;

FIG. 3 is a block diagram illustrating a structure linking various home electronic appliances according to the present invention;

FIG. 4 is a block diagram illustrating resource common sharing system;

FIG. 5 is a block diagram illustrating a structure of management unit of the present invention;

FIG. 6 is a block diagram illustrating a structure of interface unit joining with buses and interfaces;

FIG. 7 is a chart illustrating kinds, quantities and statuses of resources in a register system of the management unit;

FIG. 8 is a flow chart of the resource common sharing system during working;

FIG. 9 is a block diagram illustrating the first is a block diagram illustrating the first embodiment of the interface unit being joined to the electronic appliances;

FIG. 10 is a block diagram illustrating the second embodiment of the interface unit being joined to the electronic appliances; and

FIG. 11 is a block diagram illustrating the third embodiment of the interface unit being joined to the electronic appliances.

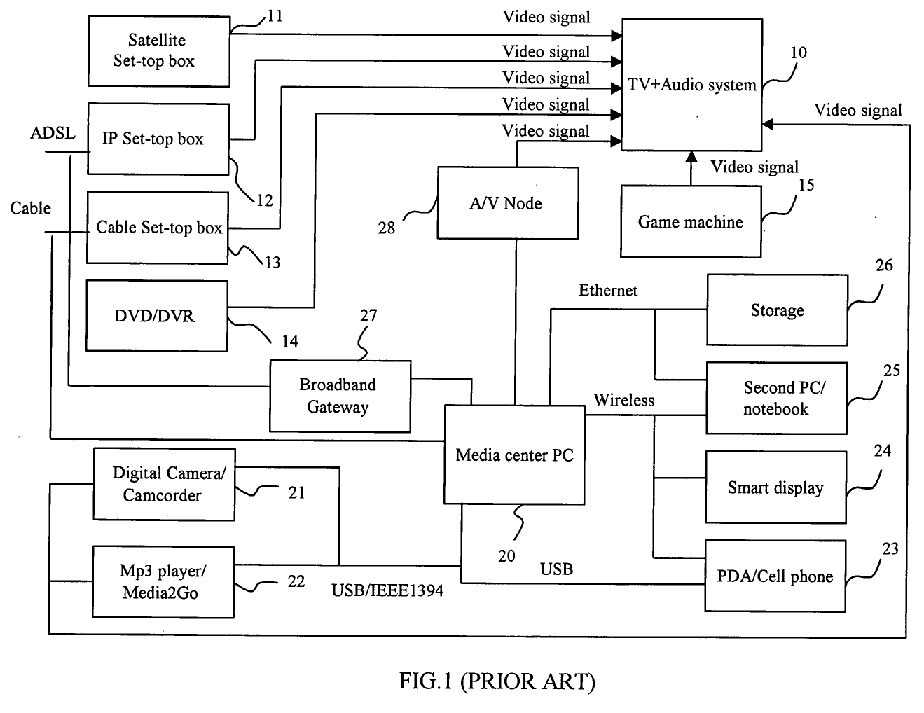

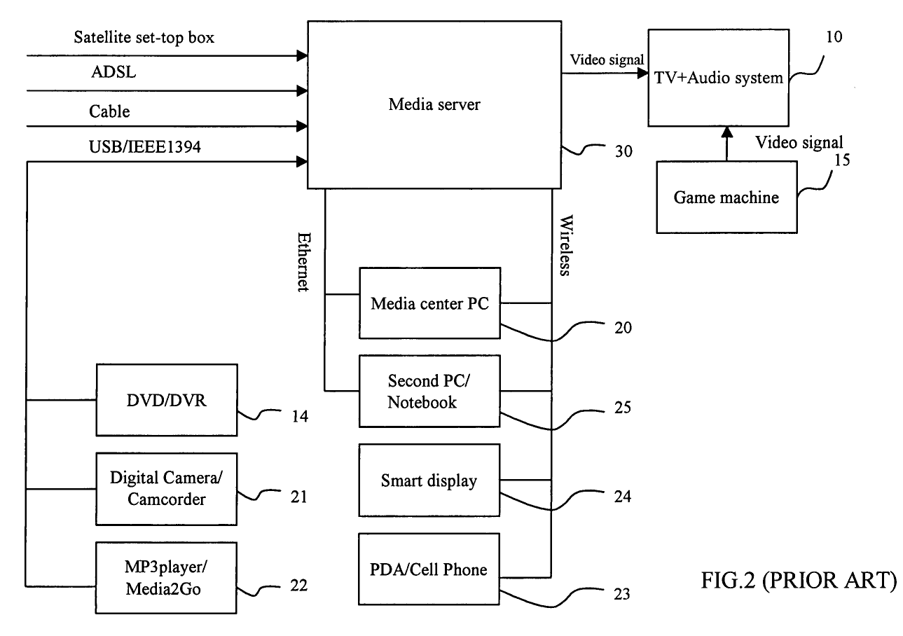

### DETAILED DESCRIPTION OF THE PREFERRED EMBODIMENTS

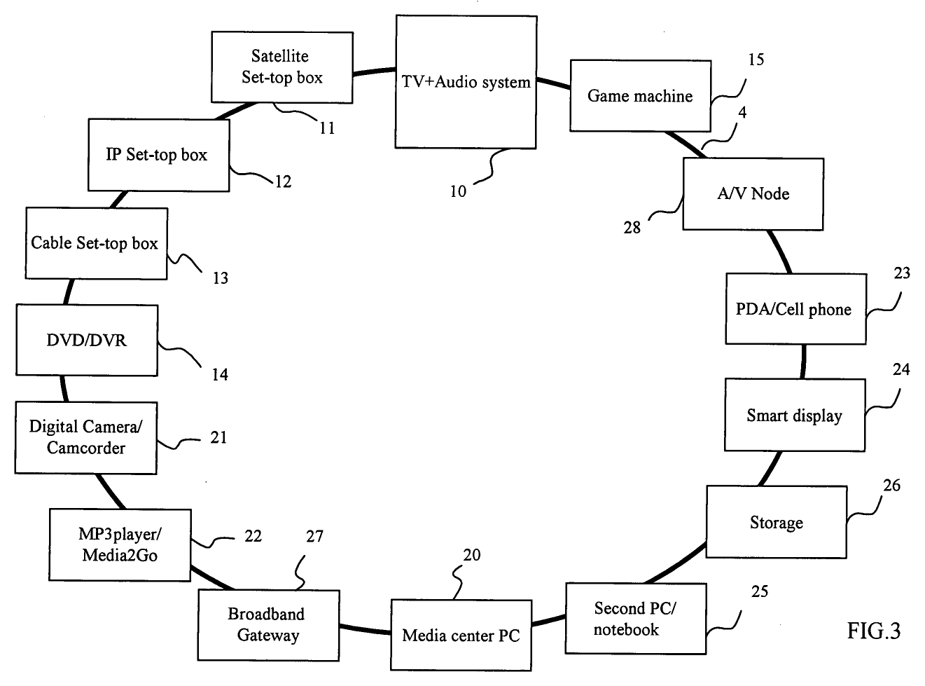

Referring to FIG. 3, a resource common sharing system for home electronic products according to the present invention is to utilize a management system 4 joined to various home electronic products to constitute the resource common sharing system.

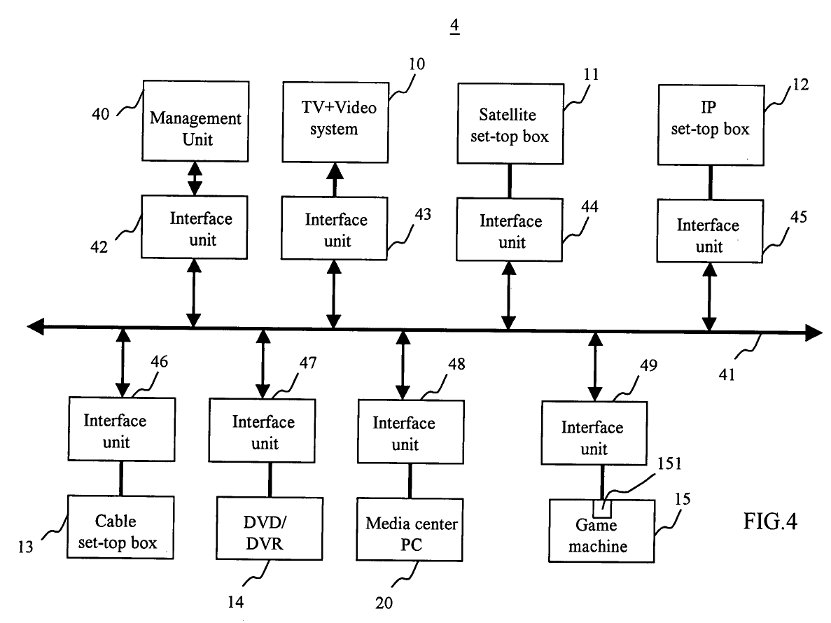

Referring to FIG. 4, the management system 4 includes a management unit 40, a bus 41 and a plurality of interface units 42, 43, 44, 45, 46, 47, 48 and 49. The interface units 42, 43, 44, 45, 46, 47, 48 and 49 electrically connect with the bus 41 respectively and can be joined to the management unit 40 and the home electronic products.

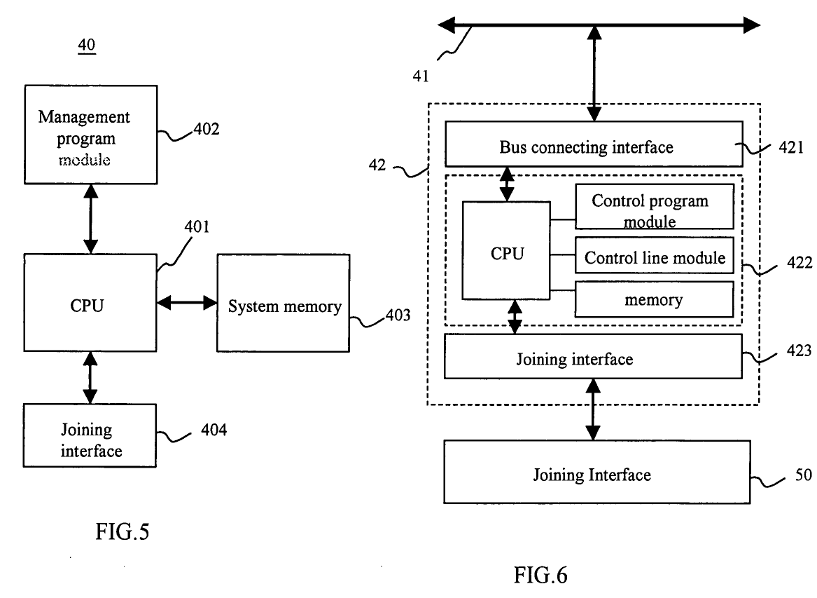

Referring to FIG. 5, the management unit 40 has a central processing unit (CPU) 401 in conjunction with a management program module 402, a system memory 403 and a joining interface 404. The management program module 402 drives a program, which manages the whole system so that the CPU can execute management of the whole system. The system memory 403 is used for recording operation status of the whole system management. The joining interface 404 is used for connecting the interface unit. The management unit 40 can detect, monitor and record types and quantity of the electronic products and hardware resource provided in each electronic product. Status of each electronic product, for instance, being in use or out of order, also can be detected, monitored and recorded.

Referring to FIG. 6, the interface unit of the present invention, taking the interface unit 42 as an example, has a bus connecting interface 421, a bus controller 422 and a joining interface 423. The bus connecting interface 421 is electrically connected to the bus 41. There are different types for the joining interface 423 such as USB interface, IEEE1394 interface, video signal interface, Ethernet interface and SATA. The joining interface 423 is connected to the management unit or a corresponding joining interface 50 of the home electronic products as shown in FIG. 6. The joining interface 423 also can be joined to a bus switch and the bus switch is connected to hardware resource of the electronic products directly. The bus controller 422 allows the CPU connecting with control circuit module, control program module and memory. The control circuit module and a working program in the control program module for driving bus controller 422 in company with the memory allow the CPU to control output signal of the bus connecting interface 423 being changed the format thereof to transmission format, which is compatible with the bus connecting interface 421. Further, the CPU controls transmission signals between the bus connecting interface 421 and joining interface 423 and monitors status of the transmission signal. The bus controller 422 of each interface unit 42 has an independent assigned address to allow the management unit 40 shown in FIG. 5 being able to detect different interface units 42 after the bus 41 being connected. The respective interface unit 42 is capable of detecting what type the electronic product connected to it is and detecting messages, such as if the resource is in use or out of order, and sending the message to the management unit. The interface unit can offer function of signal communication between various different electronic products and can control available resource of each electronic product for being used by the system.

Referring to FIGS. 4, 5 and 6 again, while the management system is in practice, the plurality of interface unit 42, 43, 44, 45, 46, 47, 49 are electrically connected to the bus 41 and the management unit 40 and various home electronic products such as TV audio system 10, satellite set-top box 11, IP set-top box 12, Cable Set-top Box 13, DVD/DVR 14, Game Machine 15 and Media Center PC 20 are connected to the bus 41 respectively. Hence, the management unit 40 can be associated with the electronic products as a system via the bus 41.

The bus controller 422 of each interface unit 42, 43, 44, 45, 46, 47, 48, 49 can detect what type and amount of each hardware unit of the electronic product connected to it and detect resource messages such as each hardware being in a state of working or idling and all the messages are saved in the system memory 403. Hence, the management unit 40 can learn and record messages of types and amount of all hardware resources in the home electronic products common sharing system and if the hardware resources are in use. Another way is each hardware unit such as the game machine 15, is established a resource status display unit 151 to show working status of the game machine 15. The bus controller 422 checks the resource status display unit on schedule to realize if each resource is in a state of use and then the bus notifies the CPU 401 in the management unit 40 to execute detection.

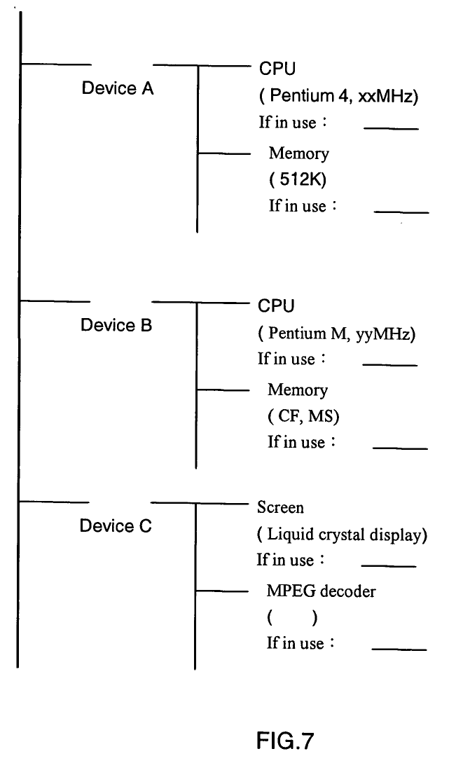

An embodiment of the management unit 40 recording resources of various electronic products can be explained with the example illustrated in FIG. 7. For instance, the home electronic resources have device A (tabletop computer), device B (notebook computer), device C (television). The device A is provided with CPU Pentium 4′xxMHg) and memory (512K). The device B is provided with CPU (Pentium M′ yyMHg) and memory (CF, MS). The device C is provided with a screen and a MPEG decoder. Further, there are records relating to if the preceding hardware resources are in use.

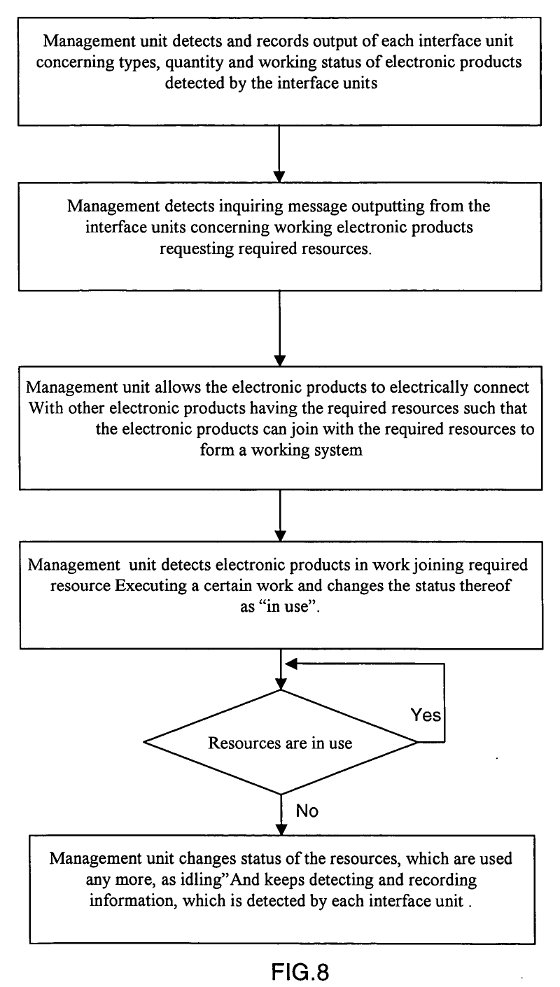

Referring to FIG. 8, a method for common sharing electronic product resources includes following steps:
(1) A management unit detects and records types and amount of resources of electronic products and statuses thereof, which are connected to and have been detected by a corresponding interface unit, and the messages are output via a bus;
(2) The management unit outputs messages related to required resources being in a state of idle once the electronic products are running and output message of required resources request via the interface unit.
(3) The management unit allows the running electronic products to connect with other electronic products, which have the required resources, and a working system is constituted.
(4) The management unit detects the running electronic products performing a certain work with the required resources and changes the status as “in work”.
(5) The interface unit keeps detecting the resource being in use. If the used resource is continuously in use, the management keeps detecting. If the used resource is stopped being used, the management unit changes the status as “in idling”.

The preceding step (3) further includes the management unit sending an instruction to the interface units and the bus controller of the interface unit controlling resources of the electronic products connected to it to allow unnecessary resources being stopped using and necessary resources being associated with the running electronic products as a working system. It is implemented that once the bus controller of the interface unit has detected messages transmitted by the management unit being related to a certain idling resource of the electronic products connected to the management unit, a control signal is sent out by the controller to stop rest resources of the electronic products except the required resources being electrically connected to the bus so that the running electronic product, which is ready to perform a certain work, can join the required resource as a working system.

Embodiments of the interface unit controlling various resources of the electronic products connected to it joining together as a working system are explained hereinafter:

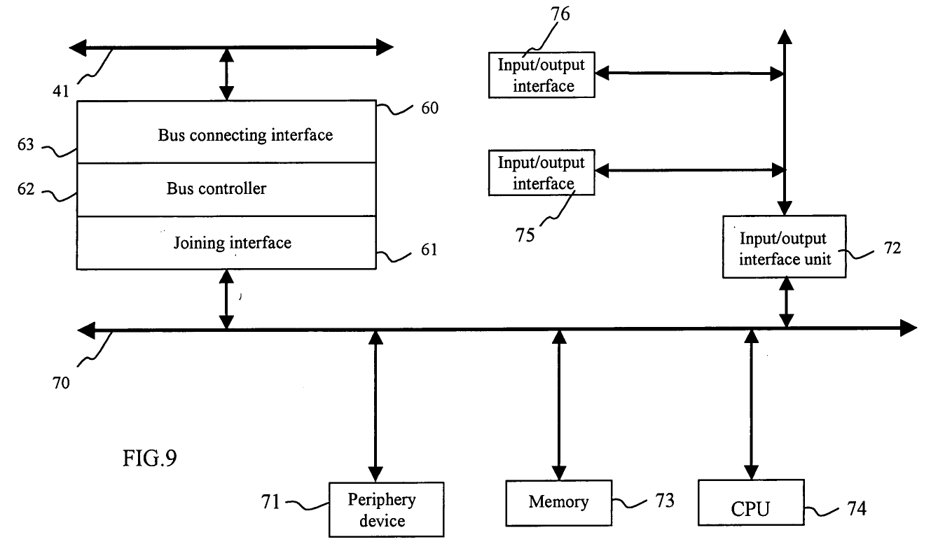

1. Referring to FIG. 9, the joining interface 61 of the interface unit 60 is connected to the bus 70 of the electronic product and the bus controller 62 sends a control signal to detect if each resource such as periphery device 71, input and output control unit 72, memory 73 or CPU 74 is running and connected to the bus 70. The resource is connected to the interface unit 60 and connected to the bus 41 via the bus connecting interface 63. Wherein, the input/output unit 72 is connected to input and output interfaces 75, 76.

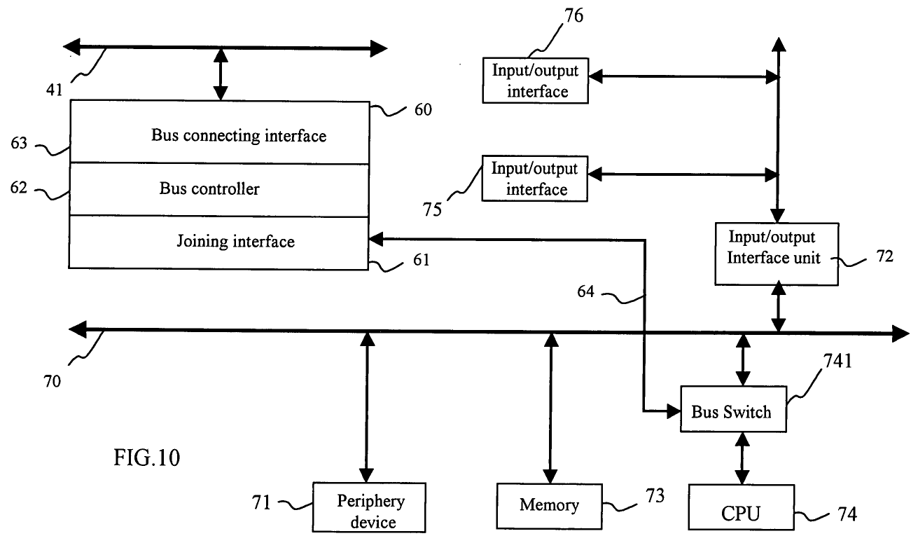

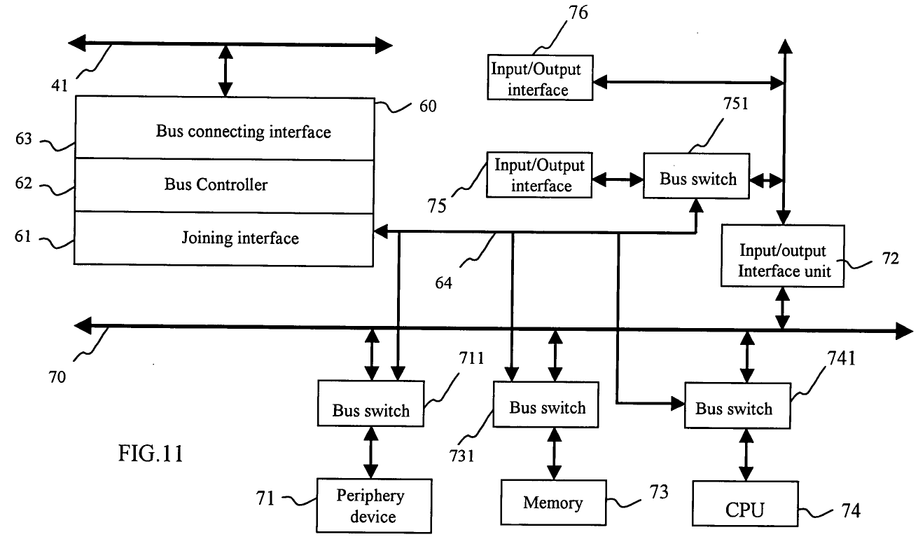

2. Referring to FIG. 10, the joining interface 61 of the interface unit 60 is connected to an electrical lead wire 64 and another upper end of the lead wire 64 is connected to a bus switch 741. The bus switch 741 further connects with an available resource in an electronic product such as CPU 74. When CPU 74 is ready to be used by other electronic products, the bus controller 62 sends a control signal to allow unused resources such as periphery device 71, input/output control unit 72 and memory 73 stopping running and allow the bus switch 741 being turned on such that CPU 74 can electrically connects with the interface unit 60. Referring to FIG. 11, the present embodiment also allows other resources connecting with a bus switch 711, 731, 751 and then to the connecting unit 61 so as to allow each resource such as periphery device 71, memory 73 or input/output interface 75 being connected to the interface unit 60 and controlled by the bus controller 62.

The present invention allows home electronic products being joined as a resource-sharing system. When any one of the electronic products is ready to perform a work, which is incapable of being handled by hardware of the specific electronic product itself, resources of other electronic products can be joined through the resource-sharing system to establish a working system for completing the work. Hence, the user only needs to purchase required products instead of buying the same resources repeatedly so as to reduce expense for obtaining the electronic products.

The present invention can overcome deficiency of the current home electronic products joining structure such as complicated wiring or central power control so that simple and neat wiring can be obtained and all the electronic products can combine as a system to share software and hardware resources. Hence, the present invention can provide powerful function during operation and each electronic product has capability of independent operation such that it is easy to renew each electronic product and operations of other related electronic products are not influenced.

While the invention has been described with referencing to preferred embodiments thereof, it is to be understood that modifications or variations may be easily made without departing from the spirit of this invention, which is defined by the appended claims.

1. A home electronic resource-sharing system, comprising:
a bus;
a plurality of interface units, being electronically connected to the bus;
a management unit, being electrically connected to one of the interface units;
a plurality of home electronic products, each of the electronic products providing hardware resource and being electrically connected to rest of the interface units to constitute a system;
wherein, the management unit detects, control and recording the respective electronic product with the hardware thereof and if the respective electronic product is in use;
the interface units executes signal transmissions between different electronic products; and
the electronic products are controlled to supply the resource thereof to the system in case of the resources thereof being available.

2. The resource-sharing system as defined in claim 1, wherein the management unit further comprises a first central processing unit (CPU) being associated with a management program module, a system memory and a first joining interface; the management program module comprises a program to enable CPU executing the management of the system; the system memory is used for tracking working status of the system; and the first joining interface is used for connecting the interface units.

3. The resource-sharing system as defined in claim 1, wherein each of the interface units has a bus connecting interface, a bus controller and a second joining interface; the bus connecting interface is used for electrically connecting with the bus; the second joining interface is used for connecting with one of the electronic products; the bus controller has a second CPU connecting with a control circuit module, a control program module and a memory so as to transform output signal format of the bus connecting interface to transmission format accepted by the second joining interface and to transform output signal format of the second joining interface to transmission format accepted by the bus connecting interface.

4. The resource-sharing system as defined in claim 3, wherein the bus controller controls communication signals between the bus connecting interface and the second joining interface and monitors transmission status of the communication signals.

5. The resource-sharing system as defined in claim 3, wherein the bus controller has an independent assigned address so that the management unit can detect and communicate with each of the interface units.

6. The resource-sharing system as defined in claim 3, wherein the second interface unit is selected from USB interface, IEEE1394 interface, Video signal interface and Ethernet interface.

7. The resource-sharing system as defined in claim 3, wherein the second joining interface connects with a bus on one of the electronic products.

8. The resource-sharing system as defined in claim 3, wherein the second joining interface is joined to at least one bus switch and the bus switch is joined to the hardware resource of one of the electronic products.

9. A method for sharing resources of electronic products comprising following steps:
(1) a management unit detecting and recording types and amount of the resources and statuses of the resources detected by a plurality of interface units and being output via a bus;
(2) The management unit outputting idle resource from electronic products to the request from electronic products short on resource by the interface units;
(3) The management unit allowing the running electronic products to connect with other electronic products, which have the idle resources, so as to constitute a working system;
(4) The management unit detects and change the state of the idle electronic product supporting the running electronic to “in work” and
(5) The interface unit detecting if the idle resources are still being used; the management unit keeping detecting in case of the idle resources continuing to be used and changing the statuses of the required resources as “in idling” in case of the idle resources being stopped using.

10. The method as defined in claim 9, wherein step 3 further comprises the management unit sends an instruction to the interface units and a bus controller of the interface units controls resources of the electronic products connected to it to allow unnecessary resources being stopped using and required resources being associated with the running electronic products as a working system.

11. The method as defined in claim 9, wherein step 1 further comprises a bus controller of each of the interface units detects a resource status display unit of each of the electronic products on schedule to obtain information of each resource being in use.

12. The method as defined in claim 10, wherein a joining interface of each of the interface units at least connects with a bus switch and the bus switch connects with hardware of the electronic products so that the bus controller can send control signal to stop unnecessary resources and can turn on the bus switch to electrically connect the required resources with the interface units.
